(19) United States
(12) Patent Application Publication
(10) Pub. No.: US 2026/0338206 A1
(43) Pub. Date: Oct. 29, 2026

(54) HYDRAULIC ASSEMBLY WITH TRANSFER PORT AND LIFTING DEVICE

(71) Applicant: Nussbaum Automotive Lifts GmbH, Kehl-Bodersweier (DE)

(72) Inventors: Simon Mull, Kehl-Bodersweier (DE); Sergej BREITENBICHER, Durmersheim (DE); Ludwig HUBER, Willstätt (DE)

(73) Assignee: Nussbaum Automotive Lifts GmbH, Kehl-Bodersweier (DE)

(21) Appl. No.: 19/104,853

(22) PCT Filed: Sep. 7, 2023
(86) PCT No.: PCT/EP2023/074602

§ 371 Date: Feb. 19, 2025

(30) Foreign Application Priority Data
Sep. 7, 2022 (DE) 10 2022 122 724.3

(51) Int. Cl. F15B 11/22; B66F 7/04; F15B 15/14

(52) U.S. Cl. CPC F15B 11/22; B66F 7/04; F15B 15/1447

(57) ABSTRACT

A hydraulic assembly (1) having a cylinder (3) and a piston (2), which is guided in the cylinder (3) and is shiftable between a working position and an end position. The piston (2) sealingly divides a cylinder chamber into a first sub-chamber (5) and a second sub-chamber (6) when in the working position, and the first sub-chamber (5) and the second sub-chamber (6) are connected to one another in a fluid-conducting manner by a transfer port (13) when the piston (3) is in the end position. A flow path (14) is formed in the piston (2) and runs between an end face of the piston (2) and an outer circumferential face of the piston (2), and the flow path (14) at least partially forms the transfer port (13) when the piston is in the end position.

### CROSS-REFERENCE TO RELATED APPLICATIONS

This application is a 371 National Phase of PCT/EP2023/074602, filed Sep. 7, 2023, which claims priority from German Patent Application No. 10 2022 122 724.3, filed Sep. 7, 2022, both of which are incorporated herein by reference as if fully set forth.

### TECHNICAL FIELD

The invention relates to a hydraulic assembly and to a lifting device.

### BACKGROUND

A hydraulic assembly of the aforementioned type can be used for moving heavy loads. For this purpose, the hydraulic assembly typically has a cylinder within which a piston is shiftably guided. In a working position, the piston sealingly divides a cylinder chamber into two sub-chambers. If a hydraulic fluid is conveyed into one of the sub-chambers via a feed, the piston is hydraulically shifted. By means of a piston rod connected to the piston, it is possible to transmit the shifting movement of the piston mechanically to the load to be moved.

It is common to operate multiple hydraulic assemblies simultaneously, wherein a synchronism between them must typically be ensured. This means that the pistons of the hydraulic assemblies can be brought into identical positions, in particular their end positions, as required. This is intended to prevent a load that is raised via multiple force application points getting into an unstable tilted position.

When multiple hydraulic assemblies are operated, it is also known to operate multiple hydraulic assemblies in pairs in separate hydraulic circuits, in order to achieve a high level of fail-safety. In this case, two pairs of hydraulic assemblies can be provided, wherein the pistons of a first pair of the hydraulic assemblies and the pistons of a second pair of the hydraulic assemblies are coupled to one another mechanically. In addition, each of the hydraulic assemblies of the first pair is hydraulically coupled to one hydraulic assembly of the second pair. In the event of a functional failure in one of the hydraulic circuits, a raised load can be held without sinking by means of the system pressure of the other hydraulic circuit and via the mechanical coupling of the pistons. A hydraulic circuit diagram of a lift with two hydraulic assemblies coupled mechanically in pairs and connected crosswise is shown in DE 10 2014 113 301 A1, for example.

However, wear phenomena on the seals or other components of the hydraulic assemblies can cause hydraulic fluid to escape from one of the hydraulic assemblies as a result of leaking. Furthermore, temperature differences can cause the hydraulic assemblies to expand to correspondingly different extents. This can result in a variation in the amount of hydraulic fluid that is necessary to be able to bring the pistons of multiple hydraulic assemblies into their respective end positions in a synchronized manner.

In the case of the above-described arrangement with two pairs of hydraulic assemblies, by means of which a high level of fail-safety is achieved, pressure differences can also arise between the hydraulically coupled hydraulic assemblies. To avoid a mechanical stress between the mechanically coupled hydraulic assemblies, it is desirable to be able to carry out pressure equalization.

A possibility of achieving the desired synchronization and the pressure equalization between multiple hydraulic assemblies consists in connecting a first hydraulic assembly in a manner known per se to a hydraulic fluid source, via which the amount of hydraulic fluid required to bring the piston of the hydraulic assembly into its end position can always be provided. The first hydraulic assembly is designed such that its piston, when in its end position, opens a transfer port via which the first and the second sub-chamber of the first hydraulic assembly are connected fluidically to one another. By means of such a transfer port, hydraulic fluid can therefore pass from the first sub-chamber into the second sub-chamber of the first hydraulic assembly and then be conveyed by means of an overflow line from the second sub-chamber into a second hydraulic assembly in order to bring the piston thereof into its end position as well. In this way, the synchronization between two hydraulic assemblies can be achieved with a low number of hydraulic components and in particular with only one hydraulic fluid source. Furthermore, pressure equalization between the first and second hydraulic assemblies can take place by means of the transfer port.

A design of the transfer port is known from EP 2 428 482 A1. For this purpose, the inner side of the cylinder has a recess, which is formed at the end in the inner side of a cylinder. If the piston is in a working position, the recess is completely within a sub-chamber of the cylinder. If the piston passes into its end position in the region of the recess, a fluid-conducting connection between the two sub-chambers of the cylinder of the hydraulic assembly is formed on the cylinder inner side.

A disadvantage of the previously known design of the transfer port consists in that, when the piston is in the end position, the hydraulic fluid must flow past the piston outer side over the entire piston height in order to pass from one sub-chamber into the other sub-chamber of the cylinder. In the process, in particular the seal elements, which can be arranged on the outside of the piston, are subjected to a high level of loading. This is associated with high wear and thus also with a high need for maintenance and repair of the entire hydraulic assembly.

### SUMMARY

The invention is therefore based on the object of proposing a hydraulic assembly that has a transfer function and is associated with a lesser need for maintenance.

The object is achieved by a hydraulic assembly having one or more of the features disclosed herein. The object is also achieved by a lifting device having one or more of the features disclosed herein. Advantageous embodiments can be taken from the following description and claims.

The hydraulic assembly according to the invention has a cylinder and a piston guided in the cylinder in a manner known per se. The piston is shiftable between a working position and an end position. In the working position, the piston sealingly divides a cylinder chamber into a first sub-chamber and a second sub-chamber. In the end position of the piston, the first and the second sub-chamber are connected to one another in a fluid-conducting manner by means of a transfer port.

It is essential to the invention that a flow path is formed in the piston and runs between an end face and an outer circumferential face of the piston, and that the transfer port is at least partially formed by the flow path when the piston is in the end position.

The hydraulic assembly according to the invention is associated with advantages in terms of its service life and the necessary maintenance measures. This is because the design according to the invention of the flow path allows a hydraulic fluid flow to be conducted between two sub-chambers of the hydraulic assembly in the manner of a bypass line, wherein damaging contact with functionally critical components on the outer circumferential face of the piston can be avoided. For example, at least one piston seal or a guide band is arranged on the outer circumferential face between an opening of the flow path in the end face and an opening of the flow path in the outer circumferential face in relation to the longitudinal axis of the piston.

According to the invention, the flow path is formed inside the piston and is completely enclosed by the piston at least in some portions. Furthermore, the invention is not limited to a certain course of the flow path or to a cross-sectional geometry. In a simple embodiment, the flow path can run in the shape of a straight bore from the end face of the piston to the outer circumferential face thereof. Alternatively, the flow path in the piston can comprise two blind bores that intersect in the regions of their bore bottoms and are thereby connected to one another in a fluid-conducting manner. In this case, one of the blind bores is arranged in the end face, and the other of the blind bores is arranged in the outer circumferential face of the piston.

In a simple design, the piston can be guided sealingly inside the cylinder when in a working position, as is known per se. In this case, one end of the flow path opens into one of the two sub-chambers of the cylinder at the end face of the piston. The other end of the flow path at the outer circumferential face of the piston faces in the direction of the cylinder inner wall against which the piston is sealingly guided. If hydraulic pressure is applied to the piston in this working position, at the end face in which the flow path is formed, the piston is displaced as far as its end position in a manner known per se. When the end position is reached, the flow path can open directly into the second sub-chamber at the outer circumferential face of the piston. It is therefore within the scope of the invention that the transfer port is formed exclusively by the flow path when the piston is in the end position. In another embodiment, however, a further fluid path is provided, which likewise forms a part of the transfer port and by means of which the fluid-conducting connection between the two sub-chambers is created.

Within the meaning of the invention, the end position of the piston is not limited solely to a single position of the piston inside the cylinder but also comprises a region in which the piston approaches this position. It is therefore within the scope of the invention that the transfer port is opened already when the piston is in an end position region and not only when the piston reaches its end position. Furthermore, the invention is not limited to how many end positions the piston can assume inside the hydraulic assembly. Rather, the end position of the piston can be defined by any mechanical stop inside the cylinder, for example a cylinder cover, a cylinder base or, for instance, a stop element protruding radially into the cylinder interior.

The invention is also not limited to what design the hydraulic assembly, its cylinder or the piston has. It is therefore within the scope of the invention that the hydraulic assembly is designed as a so-called synchronized cylinder or as a so-called differential cylinder. The piston preferably has a cylindrical basic shape. In addition, the piston can have, on its outer circumferential face, a circumferential profiling, which can be used for the form-fitting arrangement of sealing elements.

In an advantageous development, the flow path has a flow resistor in order to reduce a pressure of a hydraulic fluid flowing in the flow path.

By means of the above-described development, it is possible for sealing elements to be provided on the outer circumferential face of the piston and for the transferred hydraulic fluid to come into contact with them rather than being conducted past them via the flow path. Studies by the applicant have shown that in this case a damaging effect of the transferred hydraulic fluid can be lessened or completely avoided when the hydraulic pressure of the hydraulic fluid is reduced beforehand. In this connection, the flow path inside the piston can be used not only for the design of the transfer port but also at the same time for the arrangement of the flow resistor that is used for pressure reduction. A reduction in the pressure of the hydraulic fluid comprises in particular a reduction in its static and/or its dynamic pressure.

In an advantageous development, the piston has, on the outer circumferential face, at least one sealing element, which is arranged axially offset from the opening of the flow path in the outer circumferential face of the piston and partially delimits the transfer port when the piston is in the end position. In this case, the sealing element is arranged downstream of the flow resistor in relation to a flow direction of the hydraulic fluid flowing in the transfer port.

Studies by the applicant have shown that the design of the flow path with the flow resistor is particularly advantageous when the transferred hydraulic fluid flows past the sealing element that is arranged on the outer circumferential face of the piston and the pressure of the hydraulic fluid is reduced by means of the flow resistor. This has a particularly positive effect on the service life of the sealing element and the operational reliability of the entire hydraulic assembly. In particular, the sealing element and the transferred hydraulic fluid are in direct contact when the piston is in the end position. In particular, the sealing element is designed to divide the cylinder chamber sealingly into the first sub-chamber and the second sub-chamber when the piston is in the working position.

The flow resistance can be set, for example, depending on a geometric feature of the flow path and/or a surface property of the flow path. The settable geometric features include, for example, the flowed-through length of the flow path and/or a curvature of the flow path and/or a macroscopic profiling. The settable surface properties include, for example, a microscopic profiling. The flow resistor can be designed both as an integral part of the flow path and as a differentially designed component that can be arranged exchangeably inside the flow resistor.

In a preferred embodiment of the hydraulic assembly, the flow resistor is an orifice plate or a throttle. By means of the orifice plate, it is possible to reduce the pressure of the flowing hydraulic fluid and to set a constant volumetric flow rate of the hydraulic fluid independently of a system pressure. Although the pressure of the hydraulic fluid can likewise be reduced by means of a throttle, the settable volumetric flow rate is typically linearly dependent on the system pressure. Accordingly, at least the dynamic pressure of the hydraulic flow can be reduced to a constant value by means of an orifice plate and can be set depending on the system pressure with an orifice plate. Despite their differing operating principles, both the orifice plate and the throttle are advantageously used to reduce the pressure of the hydraulic fluid such that in particular the sealing elements arranged on the outer circumference of the piston are protected on contact with the transferred hydraulic fluid.

The orifice plate and the throttle can each be a standardized hydraulic component, the pressure-reducing effect of which can be defined using common design rules. It is likewise within the scope of the advantageous development that the orifice plate and the throttle are each arranged in the flow path as an integral part or as differentially formed components. The advantage that can be achieved by the integral design consists in the reduction in subsequent assembly steps in which the orifice plate or the throttle must be joined to the piston. Alternatively, the orifice plate and the throttle can be installed in the piston in the form of inserts.

In a preferred embodiment of the hydraulic assembly, the flow path opens into an annular channel in the outer circumferential face of the piston.

The design of the annular channel allows the hydraulic fluid emerging from the flow path to be distributed partially or completely around the circumference of the piston. This is advantageous in particular since a transfer of the hydraulic fluid can take place independently of the rotary position of the piston. This is made more difficult in particular when the flow path in the end position must open into a fluid path on the outer circumferential face of the piston in order to form the transfer port. The annular channel therefore makes it possible to install the piston in any desired rotary position in relation to the longitudinal axis of the cylinder.

In a preferred embodiment of the hydraulic assembly, a recess is formed as a longitudinal groove in the cylinder inner wall, into which recess the flow path formed in the piston opens in the end position and which therefore forms a part of the transfer port when the piston is in the end position. The recess can extend at least in some portions parallel to a longitudinal axis of the cylinder. However, it is also within the scope of the preferred embodiment that the recess extends at an angle and/or with a curved course relative to the longitudinal axis of the cylinder.

The position and length of the recess can be used in a structurally simple manner to define how large the spatial region in which transfer takes place is to be. The longer the groove length, the further the longitudinal groove extends into the cylinder interior, and the earlier a transfer of the hydraulic fluid takes place when the piston approaches its end position. Additionally, the damping properties of the hydraulic assembly can be influenced positively on reaching the end position, since sudden stopping of the piston as a result of a mechanical stop in its end position can be avoided.

In an advantageous development, the sealing element on the outer circumferential face of the piston lies in the region of the recess along the longitudinal axis of the cylinder when the piston is in the end position. A transferred hydraulic fluid can pass through the piston and out of the flow path formed therein and, in particular at a reduced pressure, come into contact with the sealing element without damaging it. The sealing element is preferably arranged in the region of the recess such that the sealing element forms a portion of the transfer port together with the recess when the piston is in the end position.

In a preferred embodiment, two or more longitudinal grooves are distributed around the circumference of the cylinder inner side and each partially form the transfer port when the piston is in the end position. The distribution of the longitudinal grooves results in a plurality of possible transfer positions in which the exit region of the flow path can correspond with one of the longitudinal grooves when the piston is rotated. This is advantageous in particular when the piston is formed without an annular channel. If an annular channel is provided, a simultaneous transfer via the plurality of recesses is possible, wherein the hydraulic fluid can be distributed evenly over the outer circumference of the piston and can pass into the plurality of recesses.

In a simple embodiment, the recess opens directly into a sub-chamber of the cylinder at an end face of the cylinder. In this embodiment, the cylinder and the piston can be joined to one another such that the flow path of the piston, in its end position, opens into the recess directly or indirectly via the annular channel. In this embodiment, the transfer port comprises the flow path in the piston, where applicable the annular channel, and the recess via which the transferred hydraulic fluid can pass into the second sub-chamber.

In an advantageous development of the hydraulic assembly, the transfer port comprises a side port running radially through the cylinder wall when the piston is in the end position.

In a simple embodiment of the above-described development, the cylinder and the piston can be joined to one another such that the flow path of the piston, in its end position, opens into the side port directly or indirectly via the annular channel. Via the side port, the hydraulic fluid can exit from the transfer port and pass from there into the second sub-chamber. For this purpose, a hydraulic line that connects the sub-chambers to one another can simply be provided. In this embodiment, the transfer port comprises the flow path in the piston, where applicable the annular channel, and the side port via which the transferred hydraulic fluid can pass into the second sub-chamber.

In an advantageous development, the transfer port also comprises the recess, which opens into the side port. The transfer port therefore comprises the flow path in the piston, where applicable the annular channel, the recess and the side port. In this embodiment, the recess preferably has a circumferential edge, which is formed on the cylinder inner side. The recess is formed at a distance from an end-face end of the cylinder.

In an advantageous development, the sealing element on the outer circumferential face of the piston is arranged between the side port and the opening of the flow path in the outer circumferential face of the piston along the longitudinal axis of the cylinder, in particular in the region of the annular channel, when the piston is in the end position. It is thereby possible in a structurally simple manner to ensure that the sealing element of the piston is the only sealing component that comes into contact with the transferred hydraulic fluid. In particular, a situation can be avoided in which a further component, for example a guide band, that is arranged on the outer circumferential face of the piston, comes into contact with the transferred hydraulic fluid. Despite a reduced pressure of the hydraulic fluid, wear phenomena on the components of the hydraulic assembly can be prevented in this way.

In an advantageous development, a gap port is formed between the outer circumferential face of the cylinder and a cover element that closes the cylinder interior at the end face, wherein the side port opens into the gap port. Preferably, the gap port is substantially coaxial with the longitudinal axis of the cylinder.

According to the above-described embodiment, the cover element sur-rounds the outside of the cylinder and is oversized on the cover inner side relative to the cylinder outer side, at least in some portions, in order to form the gap port. The cover element can define at least one mechanical stop, which limits the shifting range of the piston within the cylinder and defines the end position. The cover element is preferably designed such that the sub-chamber into which the hydraulic fluid is to be transferred is enclosed between the cover element and an end face of the piston when the piston is in the end position. Furthermore, the cover element can have an overflow connection via which the transferred hydraulic fluid can be conducted into another hydraulic assembly.

In a preferred embodiment, a first guide band and a second guide band are arranged on the outer circumferential face of the piston and are used to guide the piston on the cylinder inner wall. The guide bands improve the support of the piston in its end position, since the transfer can at least sometimes cause asymmetrical force conditions, wherein the associated forces can be supported on the cylinder inner wall by means of the guide bands. This results in a lower mechanical loading of sealing elements, which can likewise be arranged on the outside of the piston. Preferably, at least one of the guide bands is arranged between the opening of the flow path in the end face of the piston and the opening in the outer circumferential face of the piston.

As explained above, the object on which the invention is based is also achieved by the lifting device according to the invention.

In the lifting device according to the invention, in particular a lift for motor vehicles, having at least a first and a second hydraulic hydraulic assembly operating as a lifting drive for raising the lifting device, each of the hydraulic assemblies has a feed for supplying hydraulic fluid and an overflow for discharging hydraulic fluid when the lifting device is raised.

The first hydraulic assembly is designed as a command assembly in that the overflow thereof is connected in a fluid-conducting manner to the feed of the second hydraulic assembly, which is actuated as a follower assembly. Each hydraulic assembly has a cylinder and a piston, which is sealingly guided in each cylinder and divides the corresponding cylinder interior into a first and a second sub-chamber.

At least one of the hydraulic assemblies of the lifting device has a transfer port, which is designed such that the first and the second sub-chamber of this assembly are connected to one another in a fluid-conducting manner via the transfer port at least when the associated piston is in the end position with the lifting device maximally raised or maximally lowered.

When the piston is in the end position, the transfer port corresponds with a flow path running from an end face of the piston to the outer circumferential face thereof.

Such a design of a lifting device allows the disadvantages of transfer in existing lifting devices to be circumvented by reducing the loading on components used, in particular seals. This results in a longer service life of said components and reduced frequency of maintenance. In addition, safety when working with such lifting devices is improved because transfer takes place with a high level of reliability, since the components of the hydraulic assembly are protected.

Preferably, the lifting device has at least one hydraulic assembly according to the invention or an advantageous development thereof.

### BRIEF DESCRIPTION OF THE DRAWINGS

Further advantages and embodiments can be found in the following description of exemplary embodiments with reference to the figures.

In the figures:

FIG. 1 shows a sectional diagram of a hydraulic assembly in the working position;

FIG. 2 shows a sectional diagram of the hydraulic assembly according to FIG. 1 in the end position;

FIG. 3 shows an exemplary embodiment of a lifting device having two hydraulic assemblies according to FIGS. 1 and 2, one of which is designed as a command assembly, and the other of which is designed as a follower assembly; and

FIG. 4 shows a schematic diagram of the hydraulic system of the lifting device according to FIG. 3.

### DETAILED DESCRIPTION

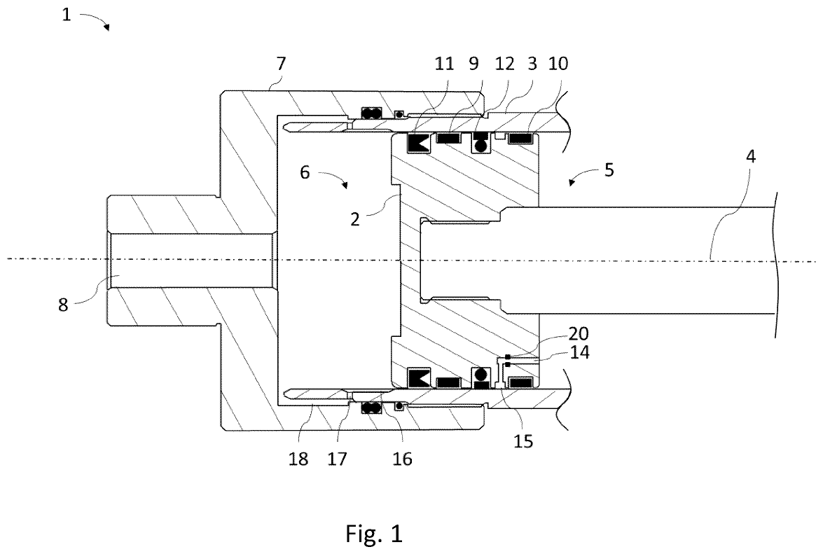

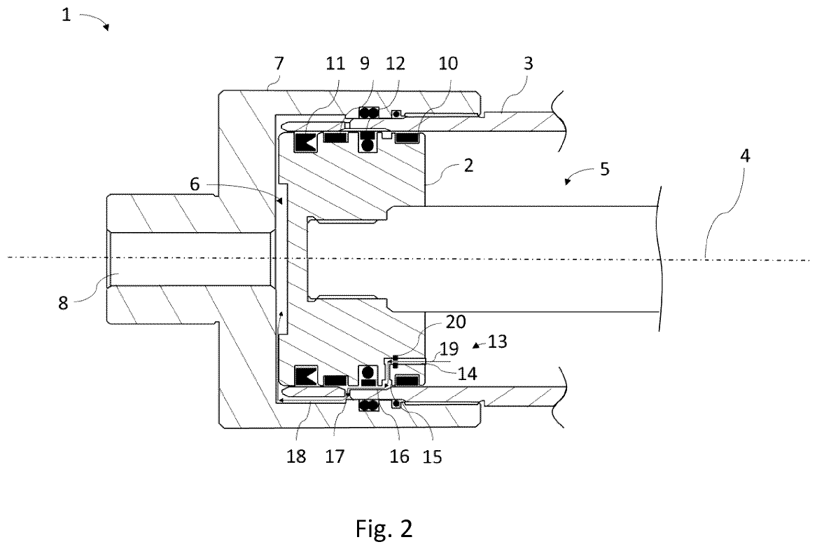

FIGS. 1 and 2 show a hydraulic assembly 1, the piston 2 of which is in a working position according to FIG. 1 and in the region of an end position according to FIG. 2.

The hydraulic assembly 1 comprises a cylinder 3, inside which the piston 2 is guided along a cylinder axis 4. If the piston 2 is in its working position (cf. FIG. 1), it divides a cylinder chamber sealingly into a first sub-chamber 5 and a second sub-chamber 6. When the first sub-chamber 5 is filled with a hydraulic fluid, the piston 2 is shifted hydraulically along the cylinder axis 4. In the process, the volume of the first sub-chamber 5 increases, while the volume of the second sub-chamber 6 is reduced. A cylinder cover 7, which delimits the second sub-chamber 6, has an overflow connection 8, via which the hydraulic fluid in the second sub-chamber 6 can escape. The piston 2 has two circumferential guide bands 9, 10 and two circumferential seals 11, 12 on its outer circumferential face. The guide bands 9, 10 are used to guide the piston 2 on the cylinder inner wall, while the seals 11, 12 are used to separate the sub-chambers 5 and 6 sealingly from one another when the piston 2 is in the working position.

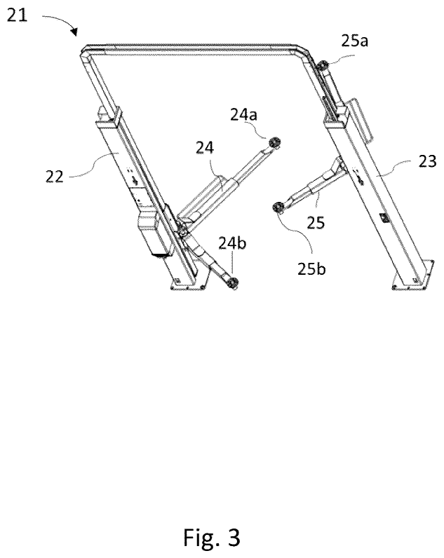

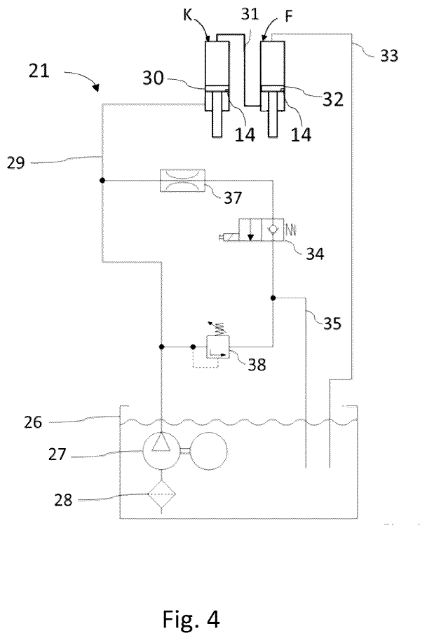

In the exemplary embodiment shown here, the hydraulic assembly 1 is used together with a further hydraulic assembly (cf. FIGS. 3 and 4) to raise a vehicle, hold it in a raised position and lower it again as required. In this case, it is desirable to be able to bring the pistons of both hydraulic assemblies inside the respective cylinders into their end positions reliably so that the raised load does not get into an unstable tilted position. However, as a result of aging phenomena, fluctuating environmental conditions and unavoidable leakage at the hydraulic seals, the amount of hydraulic fluid that is necessary to be able to bring the pistons of both hydraulic assemblies into their respective end positions can vary. To achieve this nevertheless, with low structural complexity, the hydraulic assembly shown in FIG. 1 is connected to the other hydraulic assembly via the overflow connection 8 and is designed such that, when the end position of the piston 2 is reached, hydraulic fluid can pass via a transfer port 13 (only shown in FIG. 2) from the first sub-chamber 5 into the second sub-chamber 6 first, and from there via the overflow connection 8 into the other hydraulic assembly. An unexpectedly required, additional amount of hydraulic fluid can thereby be conveyed via the first hydraulic fluid 1 into the other hydraulic fluid (cf. FIGS. 3 and 4). The structural implementation of this function is explained in detail below.

As shown in FIG. 1, the piston 2 has a flow port 14, which extends from an end face of the piston to an outer circumferential face of the piston 2. In the exemplary embodiment shown here, the flow port 14 is substantially formed from two blind bores, which intersect in the region of their respective bore bottoms and thus form a fluid-conducting connection between their respective bore openings. In the working position of the piston 2 shown in FIG. 1, the flow port 14 is closed sealingly at the outer circumferential face of the piston 2 by the cylinder inner wall. By one-sided application of pressure to the piston, the piston can be brought into its end position in the above-described manner.

In the end position shown in FIG. 2, the piston 2 is at a mechanical stop with the cylinder cover 7. In this case, the aforementioned transfer port 13 is exposed, by means of which a transfer of hydraulic fluid between the first sub-chamber 5 and the second sub-chamber 6 is possible when the piston 2 is in the end position. For this purpose, the transfer port 13 comprises a flow path 14, an annular channel 15, a plurality of recesses 16, a plurality of side ports 17, and a gap port 18 when the piston 2 is in the end position.

The design of the transfer port 14, which runs between the end face and the outer circumferential face of the piston 2, has the advantage that, when the piston 2 is in the end position, the guide band 10 does not come into contact with the transferred hydraulic fluid 19 that is conducted through the piston 2. In comparison with a previously known transfer port in which the hydraulic fluid can only flow on the outer circumferential face of the piston 2 from the first sub-chamber 5 into the second sub-chamber 6, the guide band 10 is not loaded by the transferred hydraulic fluid 19 and is thereby protected.

The annular channel 15 is designed as a circumferential groove, which runs around the outer circumference of the piston 2 and into which the hydraulic fluid can pass even when the piston 2 is in the working position. An advantage associated with the annular channel 15 consists in that the hydraulic fluid in the annular channel 15 already has a centering effect on the piston 2 when the piston 2 is in the working position as a result of its hydraulic pressure. As a result, the components 9, 10, 11, 12 arranged on the outer circumference can be loaded evenly, and therefore their wear is reduced. Moreover, the hydraulic fluid can be distributed over the outer circumferential face of the piston 2 via the annular channel 15 and thus pass into the second sub-chamber 6 via multiple recesses simultaneously.

In the end position, the annular channel 15 opens into a plurality of recesses 16, which are designed as longitudinal grooves and each run substantially parallel to the cylinder axis 4. While the guide band 10 does not come into direct contact with the transferred hydraulic fluid 19 owing to the flow path 14 in the manner of a bypass line described here, such contact is not prevented between the hydraulic fluid and the seal 12. In order still to avoid damage to the seal 12, a flow resistor 20 is arranged in the flow path 14 and is used to reduce the hydraulic pressure of the transferred hydraulic fluid in the transfer port 13. Such a reduction in the pressure has a positive effect on the wear phenomena on the seal 12. In the exemplary embodiment shown here, the flow resistor 19 is an orifice plate, which is used to reduce the static pressure of the hydraulic fluid 19 in the transfer port 13. Alternatively, the flow resistor 20 can be a throttle.

The recess 16 is designed as a longitudinal groove, which extends substantially parallel to the cylinder axis 4. The length and position of the recess is selected such that a transfer of the hydraulic fluid from the first sub-chamber 5 into the second sub-chamber 6 can already take place when the piston 2 approaches its end position and has not yet fully reached it. Such an early transfer of the hydraulic fluid makes it possible to brake the piston 2 before it reaches its end position, as a result of which sudden stopping in the movement of the raised load can be avoided.

By means of the design of the side port 17 shown here, it is possible to make the recess 16 comparatively short and thus to reduce any notch effects on the cylinder wall.

The cylinder cover 7 is oversized relative to the cylinder outer wall on a side facing the cylinder 3. In this way, a region that extends in a gap-like manner and parallel to the cylinder axis 4 is enclosed between the cylinder cover 7 and the cylinder outer wall. In the present case, this region is referred to as a gap port 18 and is used to connect the side port 17 in a fluid-conducting manner to the second sub-chamber 6. Additional hydraulic lines to connect the side port 17 in a fluid-conducting manner to the second sub-chamber 6 can thus be omitted.

An alternative embodiment of the hydraulic cylinder 1 can be designed (in a manner not shown here) such that the transfer port 13 is formed solely by the flow path 14. In this case, the opening of the flow path 14 in the outer circumferential face of the piston 2 can open directly into the second sub-chamber 6 in the region of the cylinder edge at the end when the piston 2 is in the end position. A further alternative embodiment can comprise a transfer port 13 that is designed without an annular channel 15 and wherein the flow path 14 opens directly into a recess 16 or into a side port 17 when in its end position. In a further alternative embodiment, a side port 17 and a gap port 18 can be completely omitted by selecting the position and length of the recess 16 such that said recess 16 opens directly into the second sub-chamber 6.

FIG. 3 shows a lifting device, which is designed as a lifting column lift 21. It comprises two lifting columns 22 and 23, which extend substantially vertically and on each of which arms 24 and 25, respectively, are arranged. The arms 24, 25 are vertically movable and each have the pads 24a, 24b and 25a, 25b, respectively, which are used to pick up a vehicle, to raise it by means of the lifting column lift 21 and to hold it in a raised position.

The lifting columns 22 and 23 each comprise two hydraulic assemblies (in a manner not shown in detail here), which are each designed in accordance with the hydraulic assembly 1 shown in FIGS. 1 and 2. A first pair of hydraulic assemblies is arranged in the lifting column 22, and a second pair is arranged in the lifting column 23. The pistons of the hydraulic assemblies of the first pair, which is arranged in the lifting column 22, are coupled mechanically to one another. The pistons of the hydraulic assemblies of the second pair, which is arranged in the lifting column 23, are likewise coupled mechanically to one another. In addition, a hydraulic assembly of the first pair in the lifting column 22 is hydraulically coupled to a hydraulic assembly of the second pair in the lifting column 23, i.e., connected in series in the form of a command-follower arrangement as described below.

The hydraulic assemblies coupled hydraulically to one another are each operated in a common hydraulic circuit, which is shown in detail in FIG. 4. By means of the above-described combination of mechanical and hydraulic coupling between the hydraulic assemblies of the lifting columns 22, 23, good fail-safety can be achieved. This is because, as soon as the system pressure of one hydraulic circuit falls as a result of an unexpected defect, the raised load continues to be held via the system pressure of the other hydraulic circuit and via the mechanical coupling of the hydraulic assemblies in the lifting columns 22, 23.

FIG. 4 shows a schematic diagram of the hydraulic plan of the lift 21 according to FIG. 3 and between two hydraulic assemblies K and F, which are arranged in the lifting column 22 and 23, respectively. In this case, a hydraulic assembly of the lifting column 22 acts as a so-called command assembly, and a hydraulic assembly of the lifting column 23 acts as a so-called follower assembly.

To operate the lift, a hydraulic fluid is conveyed from a tank 26 by means of a pump 27 through a suction filter 28 via a first feed line 29 to the command assembly K. As a result, a lifting movement of the piston 30 of the command assembly K takes place in the vertical direction. The hydraulic fluid displaced by the piston 30 is supplied to the follower assembly F via the overflow line 31. This has the effect that the piston 32 likewise executes a lifting movement and in the process displaces the hydraulic fluid contained in the follower assembly F, which is supplied to the tank 26 via a second overflow line 33.

If the piston 30 of the command assembly K passes into its end position before the piston 32 of the follower assembly F reaches its end position, the design of the command assembly K in the form of the hydraulic assembly 1 according to FIGS. 1 and 2 allows an overflow of hydraulic fluid via the overflow line 31. This makes it possible to simplify the hydraulic system shown in FIG. 4 by reducing the number of required components. In particular, only one pump device is needed to actuate both the command assembly K and the follower assembly F. In addition, pressure equalization can take place between the hydraulic assemblies K and F.

To move the pistons 30, 32 back in the opposite direction and to lower the raised arms, a 2/2-way valve 34 can be operated. The hydraulic fluid in the command assembly K and in the follower assembly F is displaced as a result of the weight force of the raised vehicle and supplied to the tank 26 via a return line 35. The speed of the lowering movement can be controlled via a lowering brake 37. For safety reasons, the feed line 29 and the return line 35 are connected via a further line to a pressure-limiting valve 38.

1. A hydraulic assembly (1), comprising:
a cylinder (3) having a cylinder chamber;
a piston (2), which is guided in the cylinder (3) and is shiftable between a working position and an end position, wherein the piston (2) sealingly divides the cylinder chamber into a first sub-chamber (5) and a second sub-chamber (6) when in the working position;
the first sub-chamber (5) and the second sub-chamber (6) are connected to one another in a fluid-conducting manner by a transfer port (13) when the piston (3) is in the end position;
a flow path (14) formed in the piston (2), the flow path runs between an end face of the piston (2) and an outer circumferential face of the piston (2); and
the flow path (14) at least partially forms the transfer port (13) when the piston is in the end position.

2. The hydraulic assembly (1) as claimed in claim 1, wherein the flow path (14) has a flow resistor (20), which is adapted to reduce a pressure of a hydraulic fluid (19) flowing in the flow path (14).

3. The hydraulic assembly (1) as claimed in claim 2, wherein the piston (2) has, on the outer circumferential face, at least one sealing element (12), which is arranged axially offset from [[the]] an opening of the flow path in the outer circumferential face of the piston and partially delimits the transfer port (13) when the piston (3) is in the end position, and is arranged downstream of the flow resistor (20) in relation to a flow direction of the hydraulic fluid (19) flowing in the transfer port.

4. The hydraulic assembly (1) as claimed in claim 2, wherein the flow resistor (20) comprises an orifice plate or a throttle.

5. The hydraulic assembly (1) as claimed in claim 1, wherein the flow path (14) opens into an annular channel (15) of the piston (2) at the outer circumferential face of the piston (2), and the annular channel runs substantially coaxially with a longitudinal axis of the piston (2).

6. The hydraulic assembly (1) as claimed in claim 3, wherein, when the piston (2) is in the end position, the transfer port (20) comprises at least one recess (16) in the cylinder inner wall, and the recess runs parallel to a longitudinal axis (4) of the cylinder, at least in some portions.

7. The hydraulic assembly (1) as claimed in claim 6, wherein the sealing element (12) is arranged in the region of the recess (16) along the longitudinal axis (4) of the cylinder when the piston (2) is in the end position.

8. The hydraulic assembly (11) as claimed in claim 7, wherein the sealing element (12) and the recess (16) form a portion of the transfer port (20) when the piston (2) is in the end position.

9. The hydraulic assembly (1) as claimed in claim 6, wherein two or more of the recesses (16) are distributed around an inner circumference of the cylinder (3).

10. The hydraulic assembly (1) as claimed in claim 1, wherein, when the piston is in the end position, the transfer port (13) comprises a side port (17), which runs radially through a cylinder wall of the cylinder.

11. The hydraulic assembly (1) as claimed in claim 6, wherein when the piston is in the end position, the transfer port (13) comprises a side port (17), which runs radially through a cylinder wall of the cylinder, and the recess (16) opens into the side port (17).

12. The hydraulic assembly (1) as claimed in claim 11, wherein the sealing element (12) is arranged between the side port (17) and the opening of the flow path (14) in the outer circumferential face of the piston (2) along the longitudinal axis (4) of the cylinder, when the piston (2) is in the end position.

13. The hydraulic assembly (1) as claimed in claim 11, wherein, when the piston (2) is in the end position, the transfer port (13) comprises a gap port (18), which extends between an outer wall of the cylinder and a cylinder cover (7) that fits around the outer wall, and the side port (17) opens into the gap port (18).

14. A lifting device (21), comprising:
a first hydraulic assembly and a second hydraulic assembly (1) operating as a lifting drive for raising the lifting device (21), each of the first and second hydraulic assemblies (1) has a feed for supplying hydraulic fluid and an overflow for discharging hydraulic fluid when the lifting device (21) is raised, and the first hydraulic assembly (1) is designed as a command assembly (K) in that the overflow thereof is connected in a fluid-conducting manner to the feed of the second hydraulic assembly (1), which is actuated as a follower assembly (F);
each of the hydraulic assemblies (1) has a cylinder (3) having a cylinder chamber, and a piston (2), which is guided sealingly in the cylinder (3) and divides the cylinder chamber into a first sub-chamber (5) and a second sub-chamber (6), and at least one of the first or second hydraulic assemblies has a transfer port (13), which is arranged and designed such that the first (5) and the second sub-chamber (6) of said at least one of the first or second hydraulic assemblies are connected to one another in a fluid-conducting manner via the transfer port (13) only when the associated piston (2) is in a region of an end position with the lifting device (21) maximally raised or maximally lowered; and
a flow path (14) is formed in the piston (2) and runs between an end face of the piston (2) and an outer circumferential face of the piston (2), and the flow path (14) at least partially forms the transfer port (13) when the piston (2) is in the end position.
